(19) United States
(12) Patent Application Publication
(10) Pub. No.: US 2014/0241328 A1
(43) Pub. Date: Aug. 28, 2014

(54) WIRELESS TERMINAL, INFORMATION DISTRIBUTION APPARATUS, INFORMATION DISTRIBUTION SYSTEM, AND SPECIFYING METHOD AND PROGRAM

(71) Applicant: Daisuke Kikuchi, Tokyo (JP)

(72) Inventor: Daisuke Kikuchi, Tokyo (JP)

(73) Assignee: NTT DOCOMO, INC., Tokyo (JP)

(21) Appl. No.: 14/232,763

(22) PCT Filed: Nov. 9, 2012
(86) PCT No.: PCT/JP2012/079136

§ 371 Date: Jan. 14, 2014

(30) Foreign Application Priority Data
Nov. 14, 2011 (JP) 2011-248542

(51) Int. Cl. H04W 4/20; H04W 72/02

(52) U.S. Cl. CPC H04W 4/206; H04W 72/02
USPC 370/336

(57) ABSTRACT

An information distribution system including radio devices installed in carriages; wireless terminals; and an information distribution apparatus. Each wireless terminal includes: a first communication unit receiving radio signals transmitted by the radio devices; a determination unit specifying, based on a reception time period and signal strength of the radio signals received by the first communication unit, a radio device installed in the carriage and a second communication unit transmitting data indicative of the radio device specified by the determination unit to an information distribution apparatus. The information distribution apparatus includes: a receiving unit receiving data including identification information indicative of a radio device from which a wireless terminal has received a radio signal and a carriage in which a user of the wireless terminal is aboard; a generation unit generating a content including information corresponding to the carriage based on the data received and a distribution unit distributing the content.

### TECHNICAL FIELD

The present invention relates to technology for distributing information to passengers in a carriage of a train or other vehicle.

### BACKGROUND ART

Various techniques are known for distributing information to passengers in a carriage of a train. For example, according to JP2003-140582A, in relation to advertisements in a carriage of a train, a user is able to obtain a list of additional information by wireless communication and select and download a preferred advertisement(s) included in the list.

### SUMMARY

When a wireless terminal is capable of receiving information from radio devices installed in a train, there is a possibility that a wireless terminal may receive information transmitted by a radio device other than a radio device installed in a carriage in which a user of the wireless terminal is located. For example, when a train in which a user is located passes another train running close by in an opposite direction or overtakes a train running close by in the same direction, the wireless terminal may receive information transmitted by a radio device(s) installed in the other train. Also, when a train includes two or more carriages, there is a possibility that a wireless terminal may receive information transmitted by a radio device installed in another carriage(s) of the same train.

An object of the present invention is to ensure that information relevant to a carriage in which a user is located is provided to the user.

According to an aspect of the present invention, there is provided a wireless terminal including: a first communication unit that receives a plurality of radio signals from a plurality of radio devices including a radio devices installed in a carriage of a vehicle; a determination unit that specifies, based on a reception time period and signal strength of the plurality of radio signals received by the first communication unit, a radio device installed in the carriage from among a plurality of radio devices transmitting the plurality of radio signals; and a second communication unit that transmits data including identification information indicative of the radio device specified by the determination unit to an information distribution apparatus.

Preferably, the second communication unit transmits a content including information about the carriage, the content being provided by the information distribution apparatus.

According to another aspect of the present invention, there is provided an information distribution apparatus including: a receiving unit that receives from a plurality of wireless terminals data including identification information indicative of a radio device from which a wireless terminal has received a radio signal and a carriage in which a user of the wireless terminal is aboard; a generation unit that generates a content including information corresponding to the carriage based on the data received by the receiving unit; and a distribution unit that distributes the content generated by the generation unit.

Preferably, the information distribution apparatus further includes a distribution controller that causes the distribution unit to distribute the content generated for a carriage when an amount of data relating to the carriage received by the receiving unit is greater than a threshold.

Preferably, the distribution controller evaluates the amount of data based on the threshold determined depending on a carriage.

In yet another aspect of the present invention, there is provided an information distribution system including: a plurality of radio devices installed in a plurality of carriages; a plurality of the wireless terminals; and the information distribution apparatus.

In yet another aspect of the present invention, there is provide a method of specifying a carriage of a vehicle, including: a first step of receiving a plurality of radio signals from a plurality of radio devices including a radio device installed in a carriage; a second step of specifying, based on a reception time period and signal strength of the plurality of radio signals received in the first step, a radio device installed in a carriage from among a plurality of radio devices transmitting the plurality of radio signals; and a third step of transmitting data including identification information indicative of the radio device specified in the second step to an information distribution apparatus.

There is provided a program that causes a computer to execute: a first step of receiving a plurality of radio signals from a plurality of radio devices including a radio device installed in a carriage of a vehicle; a second step of specifying, based on a reception time period and signal strength of the plurality of radio signals received in the first step, a radio device installed in the carriage from among a plurality of radio devices transmitting the plurality of radio signals; and a third step of transmitting data including identification information indicative of the radio device specified by the second step to an information distribution apparatus.

There is provided a program that causes a computer to execute: a first step of receiving from a plurality of wireless terminals data including identification information indicative of a radio device from which a wireless terminal has received a radio signal and a carriage in which a user of the wireless terminal is aboard; a second step of generating a content including information corresponding to the carriage based on the data received in the first step; and a third step of distributing the content generated in the second step.

According to the present invention, provision of information relating to a carriage in which a user is located can be provided to the user is ensured.

### BRIEF DESCRIPTION OF THE DRAWINGS

FIG. 1 is an outline of a configuration of an information distribution system.

FIG. 2 is a block diagram showing a hardware configuration of a user terminal.

FIG. 3 is a block diagram showing a functional configuration of a control unit of the user terminal.

FIG. 4 is a block diagram showing a hardware configuration of an information distribution apparatus.

FIG. 5 is a block diagram showing a functional configuration of a control unit of the information distribution apparatus.

FIG. 6 is a flowchart of processing performed by a user terminal.

FIG. 7 is an example of a screen displayed by the user terminal.

FIG. 8 is a flowchart of processing performed by the information distribution apparatus

### DETAILED DESCRIPTION

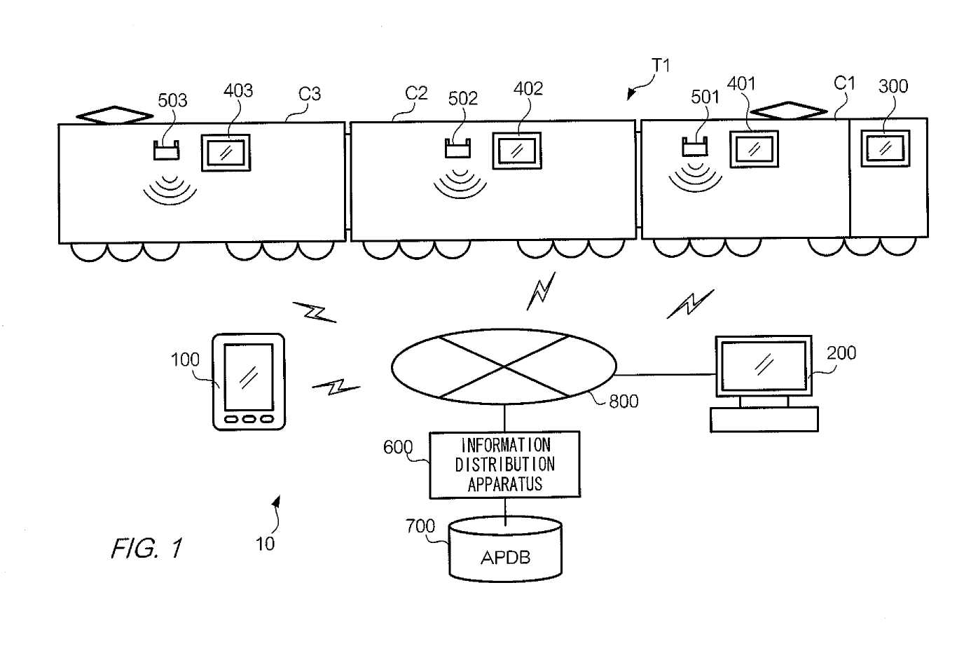

FIG. 1 shows an information distribution system 10 according an embodiment of the present invention. Information distribution system 10 according to the present embodiment is configured to distribute information corresponding to a carriage of a train carrying passengers. The train includes two or more carriages connected to one another. In FIG. 1, only one train T1 is depicted, and other trains accommodated in the system are omitted. Information distribution system 10 is configured to obtain information from two or more trains and distribute information corresponding to the trains. Similary, two or more user terminals 100 are accommodated in the system. In addition, the number of carriages included in a train is not limited to the example shown in FIG. 1 in which the train includes carriages C1, C2, and C3.

Hereinafter, the word ‘distribute’ is used to refer to transmission of information to a device or terminal that requires the information. In the embodiment, a possible receiver of distributed information includes at least one of, user terminal 100, operator terminal 200, crew terminal 300, and displays 401, 402, and 403.

Information distribution system 10 includes user terminal 100, operator terminal 200, crew terminal 300, displays 401, 402, and 403, access points (hereinafter referred to as ‘APs’) 501, 502, and 503, information distribution apparatus 600, access point database (hereinafter referred to as ‘APDB’) 700, and network 800.

User terminal 100 is a wireless terminal held by a passenger aboard train T1. Thus, a ‘user’ in this example is equivalent to a passenger of a train. User terminal 100 may be a mobile telephone (including a smart phone), a tablet device or the like. Alternatively, user terminal 100 may be a portable game console, electronic book reader, or the like. User terminal 100 is configured to perform wireless communication with distribution apparatus 600 via network 800, and with APs 501, 502, and 503 by a wireless LAN (LOCAL AREA NETWORK).

Operator terminal 200 is a communication terminal used by a party managing traffic control. Operator terminal 200 may be configured to perform communication either by wire or wirelessly. Operator terminal 200 performs communication with distribution apparatus 600. In addition, operator terminal 200 is capable of communicating with crew terminal 300.

Crew terminal 300 is a wireless terminal used by a train crew (in this case, a crew of train T1). Crew may include a conductor, driver or other train staff. Crew terminal 300 communicates with information distribution apparatus 600 via network 800. In addition, crew terminal 300 is capable of communicating with operator terminal 200.

In one embodiment, functionality of operator terminal 200 and crew terminal 300 is the same except for a difference in location, namely, location inside or outside a train. Briefly, operator terminal 200 and crew terminal 300 include at least a communication unit that communicates with information distribution apparatus 600, a display that displays information, and a controller that controls the communication unit and the display. Preferably, operator terminal 200 and crew terminal 300 are equipped with a keyboard, touch screen or other input device for input of instructions.

Displays 401, 402, and 403 are displays provided in carriages C1, C2, and C3, respectively. Displays 401, 402, and 403 communicate with information distribution apparatus 600 via network 800 to obtain a content and displays an image based on the content. Since displays 401, 402, and 403 are provided to notify information to passengers, displays 401, 402, and 403 are mounted such that they can be viewed with ease by passengers.

Hereinafter, in a case where displays 401, 402, and 403 need not be distinguished from one another, they simply will be referred to as ‘display 400’ Two or more displays 400 may be provided in a carriage, but each display need not necessarily have a communication unit. Rather, a single communication unit may be configured to receive a content and supply the content to two or more displays 400.

APs 501, 502, and 503 are radio devices installed in carriages C1, C2, and C3, respectively. APs 501, 502, and 503 function as access points for a wireless LAN. Each of APs 501, 502, and 503 intermittently transmits from an antenna a radio signal including identification information of an AP, which identification information is indicative of a carriage in which the AP is installed. Supposing that strengths of radio signals transmitted by APs 501, 502, and 503 are substantially the same. Identification information according to the present embodiment may be expressed by a character string, numeral, or a combination thereof. Predetermined rules are assigned for radio signals transmitted by APs 501, 502, and 503 such that the signals are distinguishable from those emitted by radio devices present outside the train.

Hereinafter, in a case where APs 501, 502, and 503 where it is not necessary to distinguish the APs individually, they simply will be referred to as ‘AP 500.’ In the present embodiment, a single AP 500 is installed in a carriage. In one embodiment two or more APs 500 may be installed in each carriage. When two or more APs 500 are installed in a carriage, the two or more APs 500 may transmit the same identification information indicative of the carriage. Alternatively, the two or more APs 500 installed in a same carriage may be associated in APDB 700.

Information distribution apparatus 600 is a computer that transmits content. The content is information relating to a carriage of a train, and the information may differ depending on a carriage. The content may include information (for example, news) distributed to two or more carriages. Information distribution apparatus 600 is configured to obtain data from APDB 700.

APDB 700 is a database in which an association between an access point and a carriage in which the access point is installed is described. Specifically, identification information included in a radio signal transmitted by AP 500 and a carriage identifier indicative of a carriage of a train are stored correspondingly in APDB 700. The carriage identifier is expressed by a character string, numerals, or a combination thereof, indicating a train and a carriage number of the train. Upon receipt of the identification information from information distribution apparatus 600, APDB 700 transmits a carriage identifier corresponding to the identification information to information distribution apparatus 600. APDB 700 may be incorporated in information distribution apparatus 600.

Network 800 is a network via which user terminal 100, operator terminal 200, crew terminal 300 and display 400, information distribution apparatus 600 are communicated. Specifically, network 800 includes at least a wireless network (For example, a mobile communication network) connectable by user terminal 100 crew terminal 300. Network 800 may be a combination of wireless network and other network (for example, the Internet). For example, operator terminal 200 and information distribution apparatus 600 may communicate with each other via the Internet.

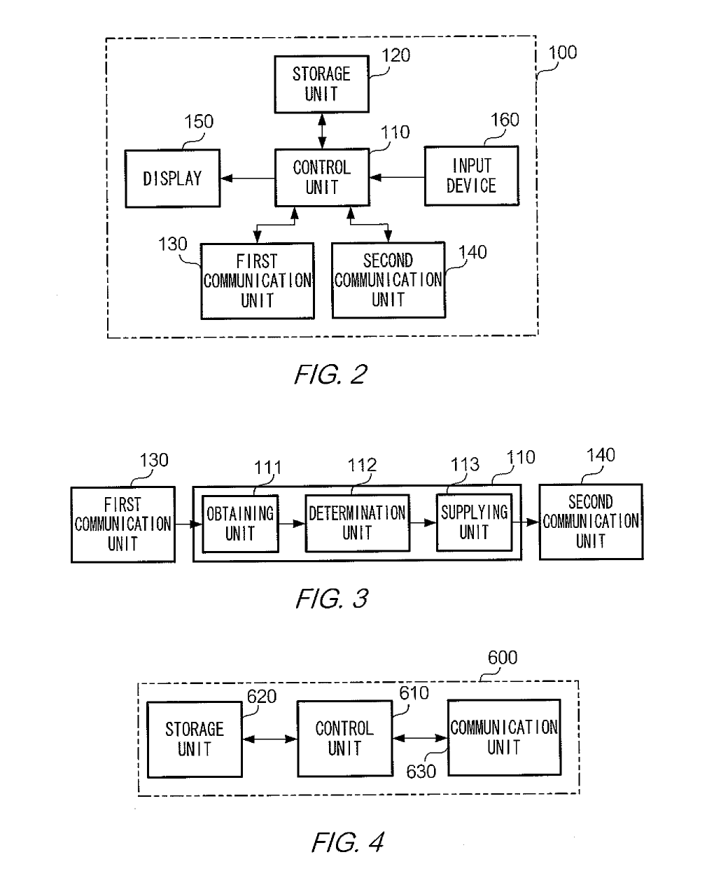

FIG. 2 is a block diagram showing a hardware configuration of user terminal 100. User terminal 100 includes at least a control unit 110, storage unit 120, first communication unit 130, second communication unit 140, display 150, and input device 160. Optionally, user terminal 100 may include a speaker, microphone, digital camera, and acceleration sensor.

Control unit 110 controls all of the units of user terminal 100. Control unit 110 includes a CPU (CENTRAL PROCESSING UNIT) or other processors, and a memory including a ROM (READ ONLY MEMORY), RAM (RANDOM ACCESS MEMORY), and the like. Control unit 110 executes a program(s) to control all the units of user terminal 100.

Storage unit 120 stores data. Storage unit 120 includes a flash memory, hard drive, or the like. Storage unit 120 can store data for processing, which processing is performed by control unit 110. Specifically, a history of communications with AP 500 and programs can be stored.

First communication unit 130 is used for communication with AP 500 or other access points of a wireless LAN. Second communication unit 140 is used for communication via network 800. Thus, in the present embodiment first communication unit 130 and second communication unit 140 are communication interfaces operable by different communication protocols.

Display 150 displays an image. For example, display 150 includes a display panel in which a liquid crystal or an organic EL (ELECTROLUMINESCENCE) element is employed, and a drive circuit that drives the elements (i.e., pixels) of the display panel. Input device 160 receives instructions input by a user. For example, input device 160 may be keys, buttons or a touch screen placed on the display panel. Input device 160 outputs data indicative of a user's instruction to control unit 110.

FIG. 3 is a block diagram showing a functional configuration of control unit 110. Control unit 110 executes a program(s) to implement functionalities of obtaining unit 111, determination unit 112, and supplying unit 113.

Obtaining unit 111 obtains a radio signal received by first communication unit 130. Obtaining unit 111 specifies the obtained radio signal, checks whether predetermined rules are assigned to the signal, and stores the rules together with a reception time period, and signal strength in RAM. Hereinafter, such stored information (rules, reception time period, and signal strength) will be referred to as ‘a communication log’. When two or more radio signals are received, obtaining unit 111 generates and stores a communication log for each of the two or more received radio signals.

Determination unit 112 determines an AP 500 installed in a carriage in which a user is aboard from two or more access points transmitting a radio signal received by first communication unit 130 based on a log of the radio signal obtained by obtaining unit 111.

Supplying unit 113 outputs data including information indicative of a result of a determination made by determination unit 112 to second communication unit 140. Second communication unit 140 transmits the data supplied by supplying unit 113 to information distribution apparatus 600. The data includes identification information included in the radio signal as information based on a result of a determination made by determination unit 112. Optionally, the data may include other information.

FIG. 4 is a block diagram showing a hardware configuration of information distribution apparatus 600. As shown in FIG. 4, information distribution apparatus 600 includes control unit 610, storage unit 620, and communication unit 630. Control unit 610 controls information distribution apparatus 600. Specifically, control unit 610 includes a processor and memory and controls all the units of information distribution apparatus 600 by executing a program(s). Storage unit 620 includes a hard drive or the like, to store data. Contents may be stored in storage unit 620. Communication unit 630 connects information distribution apparatus 600 with network 800 to perform communication with another node. Communication unit 630 receives data and distributes a content, which performs the functionalities of a receiving unit and distribution unit of the present invention.

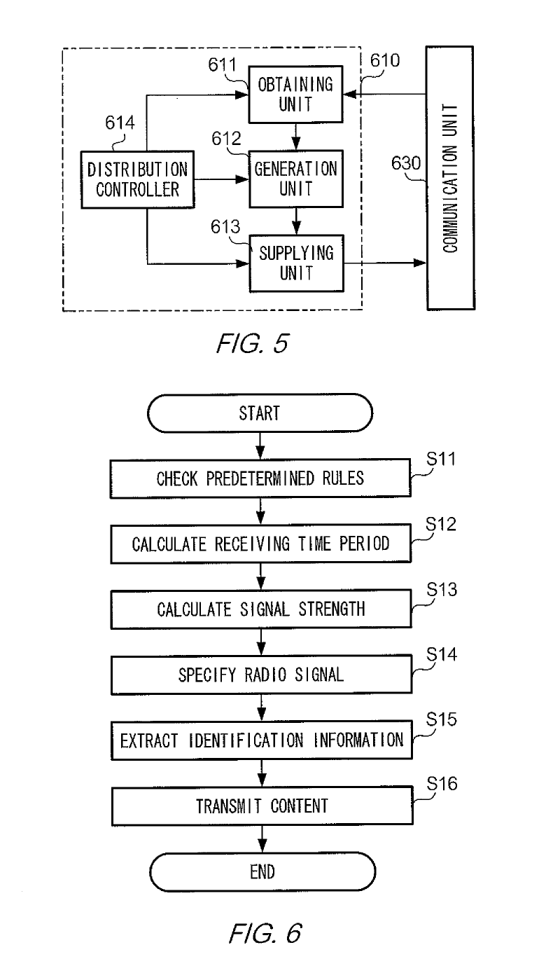

FIG. 5 is a block diagram showing a functional configuration of control unit 610. Control unit 610 implements the functionalities of obtaining unit 611, generation unit 612, supplying unit 613, and distribution controller 614 which are shown in FIG. 5 by executing a program(s).

Obtaining unit 611 obtains the data transmitted by user terminal 100 via communication unit. Obtaining unit 611 may obtain data from two or more user terminals 100 owned by different users. Generation unit 612 generates a content that is obtained by obtaining unit 611. Specifically, generation unit 612 generates content including information corresponding to a carriage, and supplying unit 613 supplies the content to communication unit 630.

Distribution controller 614 controls a timing of transmission of the content. Distribution controller 614 transmits the content when a predetermined condition is fulfilled. Distribution controller 614 may control a timing of generation of content by adjusting a timing of generation of the content by generation unit 612, or by adjusting a timing of a supply of the content from supplying unit 613 to communication unit 630. In one embodiment, distribution controller 614 is omitted from information distribution apparatus 600. In this case, information distribution apparatus 600 distributes the content without controlling a timing of transmission.

Hereinbefore, explanation of a configuration of information distribution system 10 has been made. In the configuration, a user carrying user terminal 100 boards train T1. Supposing that the user is situated in a carriage no. 2 (C2). User terminal 100 situated in C2 receives a radio signal from AP 500. It is possible that user terminal 100 may receive a radio signal(s) transmitted by an AP(s) 500 of another carriage(s) or access point(s) near the railway in addition to AP 502. The another carriage(s) may include a carriage of a train running close by to T1 in an opposite direction or in the same direction at a speed different from that of T1.

Under the circumstances, user terminal 100 estimates a carriage on which the user is aboard. The estimation is made by user terminal 100 by use of a radio signal transmitted by AP 500 for the purpose of estimation. User terminal 100 estimates a carriage in which a user is aboard, and transmits the data including identification information of the estimated carriage to information distribution apparatus 600.

FIG. 6 is a flowchart showing processes performed by user terminal 100. Control unit 110 of user terminal 100 checks an existence of the predetermined rules, a reception time period, and signal strength for each of radio signals received by first communication unit 130 (steps S11, S12, and S13). Specifically, control unit 110 refers to communication logs of the received radio signals. It is noted that the processes of steps S11, S12, and S13 can be performed in an order different from that exemplified in FIG. 6.

In step S11, control unit 110 determines whether the radio signal complies with the predetermined rules. Control unit 110 determines that a radio signal(s) that is not compliant with the predetermined rules has not been transmitted by access point AP 502 in a carriage (C2) in which a user is aboard. Thus, a radio signal(s) transmitted by an access point(s) that is not installed in train T1 is excluded by control unit 110. As a result, radio signals transmitted by wireless LAN devices (mobile routers, for example) owned by passengers are excluded.

In step S12, control unit 110 determines a reception time period during which a radio signal is received. The reception time period may be equal to a length of a time slot during which the radio signal is detected. Alternatively, the reception time period may be equal to a sum of lengths of time slots during which the radio signal is detected in a case that the radio signal is transmitted intermittently. Control unit 110 extracts a radio signal(s) within the reception time period having a strength greater than a threshold level and excludes the other radio signal(s).

In step S13, control unit 110 calculates a signal strength indicative of a strength of a received radio signal. The calculation may be performed based either on a maximum signal strength or on an average signal strength. Alternatively, the calculation may include a determination of whether changes in signal strength lie within a predetermined range (for example, less than 10%). The calculation methods described above can be combined. Control unit 110 extracts a radio signal(s) which satisfies a predetermined condition with regard to signal strength and excludes the other radio signal(s).

After completion of the processes in steps S11 to S13, control unit 110 selects a radio signal based on the results of process in step S14. Specifically, control unit 110 may select a radio signal having a maximum strength from among radio signals that have not been excluded yet. Alternatively, control unit 110 calculates points for each radio signal in steps S12 and S13 and determines a radio signal having a highest totalized point.

Next, control unit 110 extracts identification information included in a radio signal determined in step S14 (step S15). The extraction of the identification information is substantially equivalent to determination of an AP 500. Stated otherwise, in the present embodiment, control unit 110 determines identification information included in the radio signal, to determine AP 500 corresponding to the identification information. After determination of the identification information, control unit 110 outputs data including the determined identification information to second communication unit 140 from which the data is transmitted (step S16).

As shown in the foregoing, a carriage in which a user is aboard is estimated from a radio signal based on signal strength and reception time period, and thus accuracy of estimation is improved. Specifically, user terminal 100 selects an AP 500 from which a radio signal is received over a relatively long time, so as to identify an AP 500 installed in a carriage moving together with the user. As a result, a possibility of mistakenly identifying an AP 500 installed in another train running close by and that can be received over only a short duration of time, with an AP 500 installed in a carriage in which a user is aboard will be reduced. User terminal 100 selects a radio signal having greater signal strength to specify an AP 500 located closer to the user. As a result, a possibility of mistakenly identifying an AP 500 installed in another carriage of a same train with an AP 500 installed in a carriage of the same train in which the user is aboard will be reduced.

It is possible to carry out the estimation described above two or more times by user terminal 100. In one embodiment estimation is performed repeatedly at certain intervals. This is because a user can move from one carriage to another in a train or can change trains. Repeated estimations and transmissions of data performed by user terminal 100 will affect accurate identification of a carriage in which a user is currently aboard.

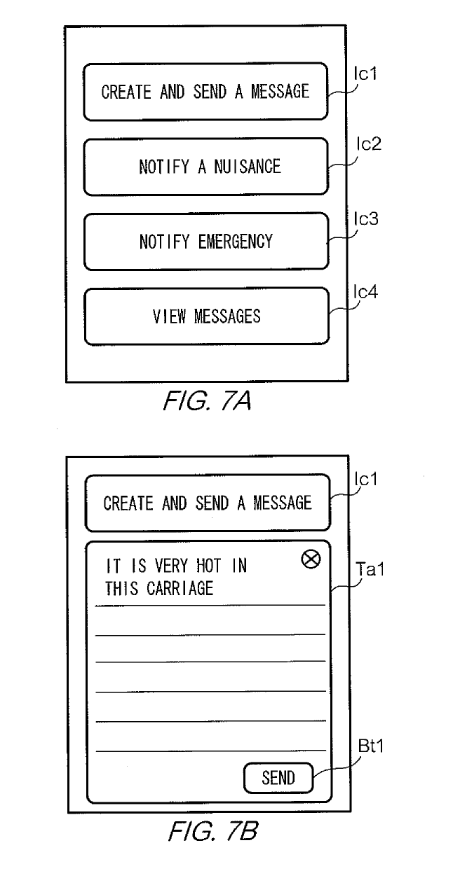

As described above, user terminal 100 may add information other than the identification information to the data. FIG. 7 exemplifies a screen displayed on display 150 of user terminal 100. User terminal 100 may download image data to display the screen from a predetermined WEB site. Alternatively, user terminal 100 may receive image data from AP 500.

Icons IC1, IC2, IC3, and IC4 are depicted in a screen show in FIG. 7A. Icon IC1 is selected by a user to report a situation pertaining to the carriage or incidents occurring in the carriage. When the user selects icon IC1, user terminal 100 displays a screen shown in FIG. 7B to receive an instruction for inputting a message made by the user. A text message input by the user is displayed in a text area TA1. Button BT1 is selected by the user to finish inputting the message.

Icon IC2 is selected to notify occurrence of a nuisance, which may include molestation, harassment, and other incidents experienced by a user in a train. Icon IC3 is selected by the user to notify an emergency. For example, this button is selected when the user notices that a passenger has suddenly become or is in some form of serious trouble. Icon IC4 is selected to view messages posted by passengers of a carriage in which the user is aboard.

User terminal 100 may transmit data responsive to selection of any one of icons IC2, IC3, IC4 and button BT1. In this case, the data including the identification information and information corresponding to a user's instruction (selection of icons) is transmitted by user terminal 100. Stated otherwise, posting and viewing of a message and notifications are managed based on the data.

Upon receipt of the data, information distribution apparatus 600 generates a content and distributes the content to appropriate users. For example, when a message is posted, information distribution apparatus 600 stores the message in association with identification information in storage unit 620. After that, upon receipt of a request for viewing messages from a user of user terminal 100, information distribution apparatus 600 specifies, based on the identification information included in the data, a carriage in which a user is aboard, and generates a content containing a message(s) posted from a user(s) in the same carriage.

Upon receipt of notification of a nuisance or emergency, information distribution apparatus 600 distributes content to at least one of operator terminal 200, crew terminal 300 and display 400. For example, in a case of notification of an emergency, when content is received display 400 displays a message such as ‘An emergency is occurring in this carriage!’ In this way, the emergency is notified to passengers in the carriage and a quick and appropriate response to the emergency can be made. In a case of notification of a nuisance, when content is received display 400 displays a message such as ‘An occurrence of a nuisance in this carriage has just been reported.’ In this way, passengers in the carriage will be notified of the nuisance. Additionally, it is expected that display of such a message will have a deterrent effect and help prevent re-occurrence of the nuisance.

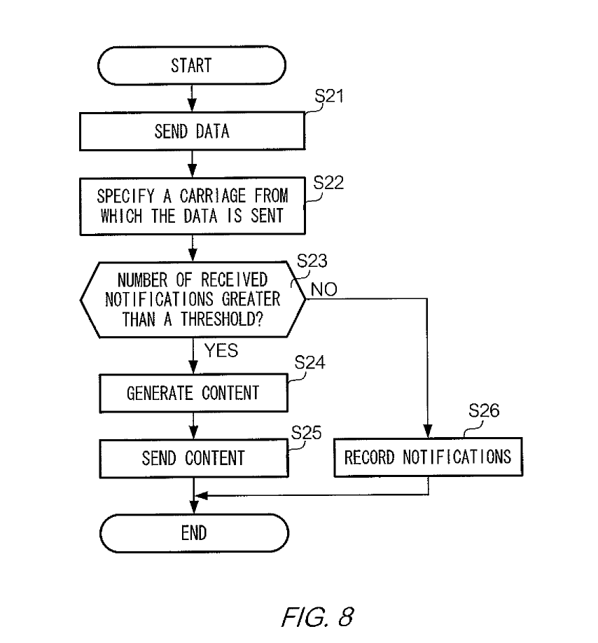

FIG. 8 is a flowchart of processes performed by information distribution apparatus 600 when a notification described above is issued. Upon receipt of data pertaining to notice of nuisance or emergency (step S21), control unit 610 of information distribution apparatus 600 specifies a carriage in which the notification was issued based on identification information included in the data (step S22). Control unit 610 can specify a type of the notification as well as the carriage in which notification is issued.

Next, control unit 610 determines whether the number of notifications (i.e., the number of received data) is greater than a predetermined based on a threshold (step S23). A threshold is introduced for each type of notification. Values of the threshold may differ depending on a type. The determination is performed for each carriage by control unit 610. Stated otherwise, control unit 610 counts the notifications for each carriage and compares the counted number with the threshold for each carriage in step S23. The counted number is stored in control unit 610 and can be used later by control unit 610.

The determination in step S23 may be repeated by a predetermined time period. For example, control unit 610 collects notifications for five minutes and determines a number of collected notifications with a predetermined threshold. By doing so, a content can be mistrusted when notifications rapidly increase.

If the number of notifications is greater than the threshold, control unit 610 generates a content (step S24) and transmits the generated content via communication unit 630 (step S25). When the number of notifications is less than the threshold. Control unit 610 records the number of notifications use of the determination of step S23 performed for the next time (step S26) before terminating the processing. Specifically, control unit 610 increments values of counters obtained for each type and carriage so as to become ready for the process of step S23 next time.

By performing the processes described above by information distribution apparatus 600, content is distributed when a predetermined number of notifications is issued by users. In this way, a notification issued with mischievous intention or other invalid notifications can be ignored.

In one embodiment, information distribution apparatus 600 may extract a particular keyword(s) from a massage posted by a user for evaluation of a situation of a carriage. For example, information distribution apparatus 600 extracts the keywords ‘drunken’, ‘dander’, ‘malfunction’, ‘hot’, ‘cold’ and the like from a message. If a number of the keywords greater than a threshold are extracted or a keyword is extracted from messages posted by more than a predetermine number of users, information distribution apparatus 600 may transmit a content corresponding to the extracted keyword to. A flowchart shown in FIG. 7 can be applied to this case.

For example, the keyword ‘hot’ or ‘cold’ is extracted from a message posted by a passenger enables the operator or train crew to recognize how the passengers feel with regard to the temperature on a carriage basis. The train crew who has recognized situations in carriages via crew terminal 300 or the operator, may change a temperature setting of a an air conditioner. Extraction of a keyword(s) relating to an event that can bring about a delay in a train can prevent the event or reduce an effect of the event.

Modifications

It is possible to implement the present invention in embodiments other than the embodiment described above. For example, the present invention can be implemented by the modified examples described below. It is noted that the modified examples can be combined to implement the present invention.

(1) A radio device according to the present invention is not limited to a access point of a wireless LAN. For example, radio device according to the present invention is a radio device compliant with BLUETOOTH (trademark), or a radio device in which an RFID (RADIO FREQUENCY IDENTIFICATION) technology is applied. A radio device according to present invention may adopt a communication protocol the same as that used in a network by which a wireless terminal and an information distribution apparatus are communicated. In this case, in a wireless terminal according to the present invention, a first communication unit is configured to receive a radio signal and a second communication unit configured for transmission may be implemented to a single hardware device.

(2) A radio device according to the present invention may transmit a carriage identifier as the identification information. In this case, APDB 700 can be omitted.

(3) In the present invention, different thresholds used for a process of step S23 may be provided depending on a train or carriage. For example, the threshold may be set according to a capacity of a carriage, or the threshold may be set differently depending on a date and time (for example, weekdays/weekend and a rush hour/other time). When information distribution apparatus obtains information on a degree of crowding for each carriage, a threshold set for each carriage may be set according to the degree of crowding of the carriage.

(4) A carriage of the present invention is not limited to a carriage of a train. For example, the present invention can also be applied to carriages included in a trolley bus or a vehicle or other transportation. Also, the present invention can be applied to a train including only a single carriage.

(5) It is possible to perform the estimation of a carriage described above based only on a reception time period or a signal strength.

An information distribution system according to the present invention includes: a plurality of radio devices installed in a plurality of carriages; a plurality of wireless terminals; and an information distribution apparatus. Each of the plurality of wireless terminals includes: a first communication unit that receives a plurality of radio signals transmitted by the plurality of radio devices; a determination unit that specifies, based on a reception time period and signal strength of the plurality of radio signals received by the first communication unit, a radio device installed in the carriage from among a plurality of radio devices transmitting the plurality of radio signals; and a second communication unit that transmits data including identification information indicative of the radio device specified by the determination unit to an information distribution apparatus. The information distribution apparatus includes: a receiving unit that receives from a plurality of wireless terminals data including identification information indicative of a radio device from which a wireless terminal has received a radio signal and a carriage in which a user of the wireless terminal is aboard; a generation unit that generates a content including information corresponding to the carriage based on the data received by the receiving unit; and a distribution unit that distributes the content generated by the generation unit.

Details of how to implement functionalities described above to hardware are not limited to the embodiment exemplified above.

(6) In addition to a wireless terminal, information distribution apparatus, and information distribution system accommodating the wireless terminal and the information distribution apparatus, the present invention provides a program executable by a wireless terminal information distribution apparatus and a method of specifying a carriage in which a user is aboard. The program may be stored in a storing medium including an optical disk. Alternatively, the program may be downloaded to a user terminal via a network including the Internet and installed therein.

1-9. (canceled)

10. A wireless terminal comprising:
a first communication unit that receives a plurality of radio signals from a plurality of radio devices including a radio devices installed in a carriage of a vehicle;
a determination unit that specifies, based on a reception time period and signal strength of the plurality of radio signals received by the first communication unit, a radio device installed in the carriage from among a plurality of radio devices transmitting the plurality of radio signals; and
a second communication unit that transmits data including identification information indicative of the radio device specified by the determination unit to an information distribution apparatus.

11. The wireless terminal according to claim 10, wherein the second communication unit transmits a content including information about the carriage, the content being provided by the information distribution apparatus.

12. An information distribution apparatus comprising:
a receiving unit that receives from a plurality of wireless terminals data including identification information indicative of a radio device from which a wireless terminal has received a radio signal and a carriage in which a user of the wireless terminal is aboard;
a generation unit that generates a content including information corresponding to the carriage based on the data received by the receiving unit; and
a distribution unit that distributes the content generated by the generation unit.

13. The information distribution apparatus according to claim 12, further comprising a distribution controller that causes the distribution unit to distribute the content generated for a carriage when an amount of data relating to the carriage received by the receiving unit is greater than a threshold.

14. The information distribution apparatus according to claim 13, wherein the distribution controller evaluates the amount of data based on the threshold determined depending on a carriage.

15. An information distribution system comprising: a plurality of radio devices installed in a plurality of carriages; a plurality of wireless terminals; and an information distribution apparatus,
each of the plurality of wireless terminals comprising:
a first communication unit that receives a plurality of radio signals transmitted by the plurality of radio devices;
a determination unit that specifies, based on a reception time period and signal strength of the plurality of radio signals received by the first communication unit, a radio device installed in the carriage from among a plurality of radio devices transmitting the plurality of radio signals; and
a second communication unit that transmits data including identification information indicative of the radio device specified by the determination unit to an information distribution apparatus, and
the information distribution apparatus comprising:
a receiving unit that receives from a plurality of wireless terminals data including identification information indicative of a radio device from which a wireless terminal has received a radio signal and a carriage in which a user of the wireless terminal is aboard;
a generation unit that generates a content including information corresponding to the carriage based on the data received by the receiving unit; and
a distribution unit that distributes the content generated by the generation unit.

16. A method of specifying a carriage of a vehicle, comprising:
a first step of receiving a plurality of radio signals from a plurality of radio devices including a radio device installed in a carriage;
a second step of specifying, based on a reception time period and signal strength of the plurality of radio signals received in the first step, a radio device installed in a carriage from among a plurality of radio devices transmitting the plurality of radio signals; and
a third step of transmitting data including identification information indicative of the radio device specified in the second step to an information distribution apparatus.

17. A program that causes a computer to execute:
a first step of receiving a plurality of radio signals from a plurality of radio devices including a radio device installed in a carriage of a vehicle;
a second step of specifying, based on a reception time period and signal strength of the plurality of radio signals received in the first step, a radio device installed in the carriage from among a plurality of radio devices transmitting the plurality of radio signals; and
a third step of transmitting data including identification information indicative of the radio device specified by the second step to an information distribution apparatus.

18. A program that causes a computer to execute:
a first step of receiving from a plurality of wireless terminals data including identification information indicative of a radio device from which a wireless terminal has received a radio signal and a carriage in which a user of the wireless terminal is aboard;
a second step of generating a content including information corresponding to the carriage based on the data received in the first step; and
a third step of distributing the content generated in the second step.
